(19) United States
(12) Patent Application Publication
(10) Pub. No.: US 2012/0317499 A1
(43) Pub. Date: Dec. 13, 2012

(54) INSTANT MESSAGING SYSTEM THAT FACILITATES BETTER KNOWLEDGE AND TASK MANAGEMENT

(76) Inventor: JIN Wen SHEN, (US)

(21) Appl. No.: 13/443,936

(22) Filed: Apr. 11, 2012

Related U.S. Application Data
(60) Provisional application No. 61/473,815, filed on Apr. 11, 2011.

(51) Int. Cl. G06F 3/01; G06F 15/16

(52) U.S. Cl. 715/752

(57) ABSTRACT

This invention discloses a novel system that is tuned for people to exchange information effectively and manage the domain knowledge and tasks productively. With a WYSIWYG-like user interface, message encapsulation into individual objects, and multithreading message flow handling, this new system is able to bring forth revolutionary features that break the limitations of traditional IM systems by knitting traditionally separated functions into an integrated business information and management platform, and hence enable new ways in building knowledge base, reading industrial specific news, and assigning and managing tasks.

### CROSS-REFERENCE TO RELATED APPLICATIONS

This application is related to U.S. Provisional Application No. 61/473,815, filed on Apr. 11, 2011, and entitled “Instant Messaging and Workflow Management System,” which is incorporated herein by reference.

### FIELD OF INVENTION

The current invention mainly involves instant messaging services. Specifically, this invention provides a method for enhancing the user experiences of communications via an instant messaging like platform among two or more users.

### BACKGROUND OF THE INVENTION

Instant messaging system or instant messenger (hereinafter, ‘IM’) has become a popular tool in today's business and casual environment. People rely on IM to exchange quick information, post questions and seek answers, transfer multimedia files, and many kinds of online activities.

IM tools, either Web browser based (such as online chat rooms), or desktop based, or handheld device based, are a type of software applications that allow users to post textual or visual information to other parties who may also have a similar such application installed in their browser or desktop, and get responses from other users ‘instantly’.

In this sense, IM communications can be done cross-platform and thru different protocols. For example, a browser based IM user can send and receive information from a desktop based IM user, or verse versa. Typically, IM system is composed of a server software and multiple client software. On the client side, IM's user interface is typically divided into two zones: one is called Message Display Zone, for displaying messages coming from all parties engaged in the conversation; and the other is called Message Input Zone, for inputting messages that would be sent to the display zone later. But this is just one of the typical arrangements for IM user interface. There exist other types of arrangements that assign one or more zones for different purposes.

IM in the prior art suffers multiple drawbacks. One of the drawbacks is in the so-called Message Input Zone, all messages from all parties are listed in a chronic order. I.e., the message posted earlier would be listed on top of messages posted later, usually judged by system clock on the server that intermediates the message exchanging process. And that order can NOT be changed once posted. This may cause great confusions if one participant of the IM conversation posted a question and while waiting for an answer from other parties in the same conversation, input other messages unrelated to the original question, since the answers to the question may be separated by those unrelated messages.

Yet another drawback in the prior art is that once a message is posted to the Message Input Zone for long, it become very hard to edit them for typo correction, clarification, earmarking, labeling, indentation, highlighting, and etc. There exists IM client software that allows user to edit the last message he/she sent out recently. But there is no way to edit messages that has been posted a long while ago. Nor is there a way to edit messages posted by other parties in the same conversation.

Yet another drawback in the prior art is that the message flow in the Message Input Zone keeps moving up whenever a new message is posted in, and the message flow can be extremely long if there are many information exchanges among participants. This becomes hard for user who wants to dwell on and study just a particular section of the message flow, or navigate back to refer previous sections for more information in a very long flow.

In a group conversation, messages from all participating parties are all displayed in the same zone. If a user is interested only to messages posted by one or more of the participants, the IM in the prior art presents no way to do so. So there exists a need to filter out all messages from just one particular individual or individuals only in current or past IM sessions.

A popular use of IM is for posting questions and seeking answers in either business or casual environment. In the prior art, the good knowledge associated with the questions and answers are deeply embedded in various IM sessions and can easily got lost. As a result, people in the same business or friend/family circles are repetitively asking the same kind or similar questions and others have to answers them times and again.

So there exists a need for IM system to facilitate the pairing, extraction, and consolidation of questions and answers in all IM sessions, and reuse the knowledge associated with the Q & A's to benefit other users either in or out of the IM system.

As a communication tool to enhance business and personal productivity, it is natural to associate IM with task management. However, IM in the prior art is not user friendly for task management.

One of the purposes of the invention is to present an IM system that allows user to more freely rearrange the order of messages displayed in the Display Zone, and hence help users better follow, understand, and manage the message flows.

Another purpose of the invention is to present a mechanism to enable users to edit the already posted messages in the display zone. Yet another purpose of the invention is to provide a mechanism for user to freeze a section of the ongoing conversation flow, and operate on it for an extensive period of time until the user unfreeze it.

Yet another purpose of the invention is to provide a mechanism for user to label, tag, or earmark individual sections of the conversations flows, current or past, and a way to quickly navigate back to these sections later.

Yet another purpose of the invention is to provide a mechanism for user to filter out and display all messages from just one particular individual or individuals only in current or past IM sessions. As an extension, such filtering can be done based on other properties of the messages, such as message content, labels, time of posting, and etc., alone or in combination.

Yet another purpose of the invention is to present a new mechanism for IM system to facilitate the pairing, extraction, and consolidation of questions and answers in all IM sessions, and reuse the knowledge associated with the Q & A's to benefit other users either in or out of the IM system.

Yet another purpose of the invention is to present a new mechanism in the IM setting, which can greatly facilitate the task management.

There are a number of other purposes and features of the invented IM, which will be disclosed in the following sections in more details.

### SUMMARY

The present invention disclosed a new method and system that greatly enhance user experiences of IM tools and improve business and personal productivities.

In one of the preferred embodiments of the invention, the IM system encapsulates each transmitted message into an object that contains the body of the message per se, as well as a system-wide unique message identifier (hereinafter, “ID”), the sender's ID, sender's device ID, the recipient's ID, recipient's device ID, time of transmission, nature of the message per se, and other properties. The encapsulation may be done in XML or other similar format known to the expert in the art. The system assigns a unique ID for each object in the conversation session, be it two-party dialogue or multiple party conference, for example, by combining unique user ID and system time of message transmitting, so as to avoid later confusion system wide. It also designates operational methods that can be applied onto different types of such objects, such as drag & drop within the same window or outside the current window, edit, delete, sort/filter according to certain criteria, adding expressions, hyperlink, change properties such as font and color, repost, call-out for more attention, etc.

The invented IM system also has a Message Display Zone that possessed WYSIWYG-like properties. When messages are sent to this Message Display Zone, on the surface there is no much difference from the traditional IM display zone. However, since each message is actually an object by itself, user can drag and drop an objectified message to almost anywhere within or outside the display zone. User can also apply mouse and/or keyboard to interact with each object in the display zone in order to edit, delete, sort/filter, and many other WYSIWYG operations. A notable feature of the WYSIWYG-like display zone is that user can insert one or more new messages in between existing messages that were posted earlier. This is a feature that will be much appreciated in a question and answer session, where user can use this feature to pair a question and its answers in close proximity so as to avoid interruptions or confusions by other unrelated messages. Yet another notable feature of the display zone is that one of the participants of an IM session can select and freeze a section of the conversation, so the user can operate on this section only for an extensive period of time until he/she unfreeze the section. In the frozen section, user can carry out all kinds of operations such as posting new, editing, deleting, rearranging, and etc., as described in other parts of the disclosure.

The invented IM system also provides functions or buttons that help user seek answers to a question posted during the IM session. In one embodiment of the invention, the user is allowed to drag a question message, in its original form or an edited form, which is an object, and drop it to a Q & A zone or button, then the system will query its Q & A database, match and return the best answer(s) to the Message Display Zone or Message Input Zone, depending on the user setting. The user can further edit the answers returned by the system to best suit the original questions.

The invented IM system also provides functions or buttons that help user conduct task management during the IM session.

### BRIEF DESCRIPTION OF THE DRAWINGS

FIG. 1 is a block diagram illustrating a general process of message objectification and posting in one embodiment of the invented IM system.

FIG. 1A is the process for regular message display on both local and remote client sides of the invented IM system.

FIG. 1B illustrates the process of message display after In-place editing in message display zone of the invented IM system.

FIG. 1C illustrates the process for drag and drop in local display of the invented IM system.

FIG. 2 illustrate a typical IM Interface in the prior art.

FIG. 3 illustrates a WYSIWYG-like feature for the Invented IM—In-place editing.

FIG. 4 illustrates a WYSIWYG-like feature for the Invented IM—Highlight posted message(s) to call for more attention.

FIG. 5 illustrates a WYSIWYG-like Feature for the Invented IM—Extra requirements by user and system prompt.

FIG. 6 illustrates a WYSIWYG-like Feature for the Invented IM—rearrange order of messages.

FIG. 7 illustrates a WYSIWYG-like Feature for the Invented IM—Smart Indentation: tree node type of in-line reply.

FIG. 8 illustrates a WYSIWYG-like Feature for the Invented IM—Message Filtering.

FIG. 9 illustrates the feature of freezing a section of the message flow so user can operate on until unfrozen.

FIG. 9A illustrates the feature of operating on frozen section of the message flow.

FIG. 10 illustrates the feature of labeling sections of message flow as objects for quick navigation and reference.

FIG. 11 illustrates the feature of message thread splitting in the invented IM system.

FIG. 12 illustrates the process of web based IM to desktop based IM communications.

FIG. 13 illustrates the feature of user A posted a question, user B can interact with the knowledge base in a number of ways in the invented IM system.

FIG. 14 illustrates the interface for editing knowledge base in one embodiment of the invented IM system.

FIG. 15 illustrates the process of recursive logic for query the knowledge base of the invented IM system.

FIG. 16 illustrates the interface with task button and task zone of the invented IM system.

FIG. 17 illustrates the details of the task zone of the invented IM system.

### DETAILED DESCRIPTION

The present invention discloses a method and system that can greatly enhance user experiences and increase personal and business productivities when exchanging instant messages. A number of exemplary embodiments of the invention are described and illustrated herein. However, they are merely for illustrative purpose. It will be appreciated by those skilled in the art that various modifications in form and detail can be made therein without departing from or violating the spirit and scope of the invention as defined by the appended claims. Also, the disclosed invention is to be applicable to the widest scope covering various alternatives, modifications and equivalents consistent with the principles and features. The terminology and phraseology used is for the purpose of describing exemplary embodiments and should not be considered limiting. For the purpose of clarity, details relating to technical material that are known in the technical fields related to the invention have not been described in detail so as not to unnecessarily obscure the present invention.

With the above understandings, a number of preferred embodiments will be described and illustrated for the present invention in the following paragraphs.

A generic IM system is implemented in a group of at least two computing devices, each containing, minimally, a central processing unit, a storage mean, an input mean, a display mean, and an operating system, interconnected together in wired and/or wirelessly environment through any type of known communications protocols. These devices don't have to be physically located in one geographic location.

At any given moment, at least one such device in the above mentioned group acts as a controlling unit for the system by intermediating the information flows among all devices in the system, in the manner of server-client. The role of server doesn't have to be permanently fixed onto any one particular device in the system: the controlling function can be shifted from one device to another dynamically depending on the capacity utilization of each device.

At least one such device in the above mentioned group will also act as a web server that facilitates information receiving and posting on to any generic web browsers. The system may contain storage servers and/or database servers and/or load balancers, and/or other hardware/software installations necessary for the system to operate smoothly.

Each device in the group has at least one client program installed, which serves the functions of communicating with the controlling units and the interface for user to input and receive information. The information or message transmitted can be in the form of text, image, file, voice stream, video stream, etc.

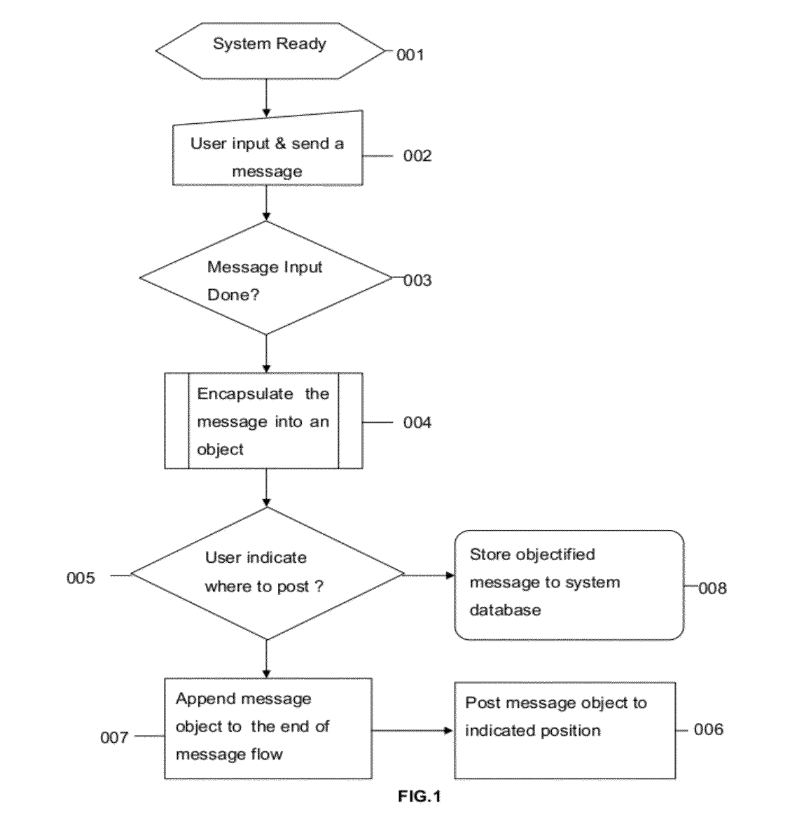

FIG. 1 illustrates the general process of encapsulating a message and posting it to the display zone. When IM system 001 is ready to use, user can input & send a message 002. After the system receives the indication 003 that the message input is done, it will initiate the process of message encapsulation 004, and the objectified message will stored in either or both the local and system database 008. If the objectified message contains an indication 005 of where the user wants the message to be displayed, the system will display the message in the designated place 006; if not, the system will append the message to the end of the message flow 007.

FIG. 1A further illustrate in more detail the process of creating and posting objectified messages in both the local and remote end of the IM system. First, when the IM client 010 at the local end is ready, it will synchronize a local timer 011 with that of the system. This will be advantageous later when system time is used to create a unique ID for each objectified message. After user done input for a message in step 012, the system will initiate the message objectification by local client 013. In one embodiment of the invention, the system will encapsulate a number of related information together into an object 014. Such information may include but not limited to: Unique System ID; Local ID; Index for Remote ID; Time Posted; Sender ID; Recipient ID; Section ID; Message Body, Message Properties; Position of Display; Permission to make changes on any part of the object; and etc. Further detailed of the encapsulation can be found in later paragraphs. After encapsulation or objectification, the message object on one hand is displayed in the designated place of the local client side, and on the other hand, it is relayed by the server (or a central controlling unit) 015 to the remote IM client side. After passing through the message interceptor 016 at the remote client side, which will check for the completeness and integrity of the transmitted message object 017, the message object is further analyzed and information extracted 018, and displayed accordingly on the remote client side 019.

FIG. 1B illustrates the process of message displaying after in-place editing actions are performed on the object. First, the local message display zone 030 is ready to be operated on. From zone 030, user selects a message object to edit in-place 031. A local editing zone is opened for the selected message in-place 032, and the user can perform various editing actions 033 such as appending, inserting, deleting, formatting, and etc., in a manner colloquially known as WYSIWYG. After the in-place editing is done, the local editing zone is closed and records of the editing actions are added to object capsule 034. From here onwards, on one hand the local display zone is refreshed to reflect the most recent editing actions 035; on the other hand, the edited message object is relayed by the server 015 to the remote IM client side. After passing through the message interceptor 016 at the remote client side, which will check for the completeness and integrity of the transmitted message object 017, the message object is further analyzed 018 and editing records extracted 036, and displayed accordingly on the remote client side 037.

FIG. 1C demonstrates the process of drag and drop in local display zones. First, the target zone 040 for the drag and drop is ready. Then user selects a message or a group of messages 041 to be dragged and drop 042 them to the target zone 043. The system will change the records in date table 048 regarding the display zone information in step 044. Specifically, an exemplary data table 048 is illustrated also on the same figure, and area that needs to be changed in 049. Then the system will refresh the local display 045, namely, deleting the selected message object(s) in old display zone 046, and display the same message object(s) in the target display zone 047.

As illustrated before, an import function of the invented IM system is the encapsulation of each transmitted message into an object that contain the body of the message per se, as well as the sender's ID, sender's device ID, the recipient's ID, recipient's device ID, section ID (which group it belongs to), time of transmission, nature of the message per se, position for display (which zone and where in the zone), Permission to make changes on any part of the object, and other properties. The encapsulation may be done in XML or other similar format. The system assigns a unique ID for each object in the conversation session, be it two-party dialogue or multiple party conference. It also designates operational methods that can be applied onto different types of such objects, such as drag & drop within the same window or outside the current window, edit, delete, sort/filter according to certain criteria, adding expressions, hyperlink, change properties such as font and color, repost, call-out for more attention, etc.

It is worth noting that in the invented IM system, each message object can be moved horizontally as well as vertically. So not only the original order of conversation can be rearranged, they can also show indentation or tree structure in the same window. I.e., a message can have child or grandchild message posted by anyone in the conversation group. They can also be hidden and shown by clicking, say, a + or − sign in front of a node.

During or after a normal IM conversation, any one party (say, user A) in the conversation can operate on these objects with designated methods allowed by the system; and he/she can choose to share his/her results of operations to any other participants of the original conversation and/or newly added participants, or not; and he/she can also decide whether to allow other participants, old or new, to alter his/her results of operations; and any other participants, old or new, can each individually choose to view the results of operations of user A on their own screen, or not; and any other participants, old or new, can individually decide if they want to accept the right to alter the results of operations of user A if it is granted by user A.

For example, if user A drags one or more objects from the conversation and drop them outside the existing window, a new window will be automatically created besides the old window, and the dropped objects will be placed into the new window, with the same order as in the old window as dictated by the aforementioned unique object ID if user A did not intentionally alter the order of message flows, and all of original properties of these objects will be carried over to the new window. Alternatively, the message objects can be dragged & dropped into pre-existing windows created by the system for such purpose. Multiple new windows can be created and used by the same token. The system will assign a default name for each window. User A can rename these windows to more appropriately reflect the theme/topic of the messages in each window.

Attributes can be assigned to objectified messages so they can be searched or rearranged easily:
For example, attributes such as ‘All files I sent’, ‘All files I received’, ‘Type of Files’, ‘Contain URL’, and etc., are useful for user to locate a specific message in a long history.
Tags/Labels can be added to messages as attributes. Such tags can either come from user's manual input, or from system suggestions (such as word/phrase parsing, or semantic network analysis), or from the name/theme of the thread (see below ‘Multiple Threads’ for more details) the message is in.

If user A chooses not to share his/her results of operations other parties, none of these new windows nor their contents are visible to any other parties of the conversation. User A can do whatever is allowed by the system, without affecting the on-going conversation from the eyes of other participants. In other words, all other parties may not even aware the manipulations done by user A in his/her end.

If user A chooses to share his/her results of operations to other parties, and any party also opt in to view these results, these new windows and/or their contents are also become visible to any other parties of the conversation who opt in to share the view of user A.

The new window contains the same group of participants as in the old window. Hence technically all other participants in the group can view the results in the new window after the first user has done the drag & drop operation. However, by using different setting on his/her own client side program, each user can decide whether to view the new window or not. If one participant chooses not to view the new window, then all he/she will see is still a continuous stream of messages posted in the existing window. If one chooses differently, he/she can view the new window with the dropped messages. His/her settings can also help decide if the dragged & dropped message will appear in the new window only or appear in both windows.

Once a new window is created, it has the same privileges and rights as the old window. User can continue move message objects into this new window from old window, or move/re-organize message objects from this new window back to the old window. And all participants who opt in to view the new windows can also view the results of such operations. By default, the positions of the message objects are controlled by the unique object ID so the original order of conversation will be perfectly preserved. So even if the order of message objects has been scrambled, say, by some kind of sorting or filtering, the original order can be easily restored by a simple click of a button.

Equal right also means any participant in the conversation group can create new windows and/or operate on the objects in these windows equally as others do. So at any moment of time, the control unit of the system has to judge which user got his/her hand on a certain object or objects first, before others.

User can create multiple new windows at the same time. Once created, all these new windows have the same rights and privileges as the old windows, as well as with each other. That is, user can work on any one of these new and old windows as the main conversation windows, and move, re-organize, or otherwise operate on message objects back and forth among all those windows smoothly.

At the same time, there is always an original conversation windows preserved for those participants who opts out of viewing objects in the new windows. The first user can lock the right to create new windows, and also can reassign this right to another member in the group.

The invented IM system allows for multiple modes of operations.

In the most restrictive mode of operation, the invented IM system will act like a traditional IM system, in the sense that it will not allow any manipulations of already posted messages in the Display Zone, nor allow any new display windows to be opened by any party in the conversation.

In a less restrictive mode, the invented IM system will allow a party to manipulate his/her own posted messages in his/her own view point. A party may also do message thread splitting or operations in newly created conversation windows.

In an even less restrictive mode, user A can choose to share the results of his/her manipulations or operations to other parties in the conversation. Hence one or more parties in the conversation will share the same view of user A. Of course, the other party/parties can refuse to view user A results, and hence stick to the most traditional views.

In the least restrictive mode, user A can apply for authorization from other party/parties of the conversation to manipulate/operate not only his/her own posted messages/new windows, but also those message posted by others and those windows created by others.

In the free-for-all mode of operation, once properly authorized by all parties, user A in the conversation can freely manipulate all posted messages and new thread windows, either of his/her own or others. In the mean time, user A's own messages and windows can also be manipulated by other party/parties in the conversation once he/she authorizes other party/parties.

If user A wants to manipulate posted messages by other party/parties in the conversation, first he/she needs to request an authorization from other party/parties.

### Embodiment 1

User A selects the ID/Name/Icon representing other party/parties in the IM interface, and select from the pop-up menu “Request for authorization on message manipulation”
The IM system sends a request to the designated party/parties. The system request may be displayed in a pop-up window to get the attention of the receiving party/parties.
The receiving party/parties can either grant the request or deny it (or simply ignore it for a preset period of time, with the same effect of denying)
The system sends back the result to user A, and user A can either start to do the manipulation if he/she gets the authorization, or repeat the requesting process if got denied.

### Embodiment 2

User A can post a normal IM message to other party/parties, saying, for example: “Please allow me to edit the posted messages of yours”. After viewing the message, other party/parties in the conversation can go to the conversation option menu of the IM and select the option to allow his/her own posted messages be manipulated by others. Other party/parties can choose to which user such authorization is granted by selecting the user/users from a list of all possible user ID's or simply typing in the user's ID. The authorization can be set at all conversation level or be limited to this particular conversation. It can also be revoked at any time during or after the conversation. Or be set as valid between a specific period of time. Once the authorization is expired, user A will not be able to manipulate other party/parties posted message.

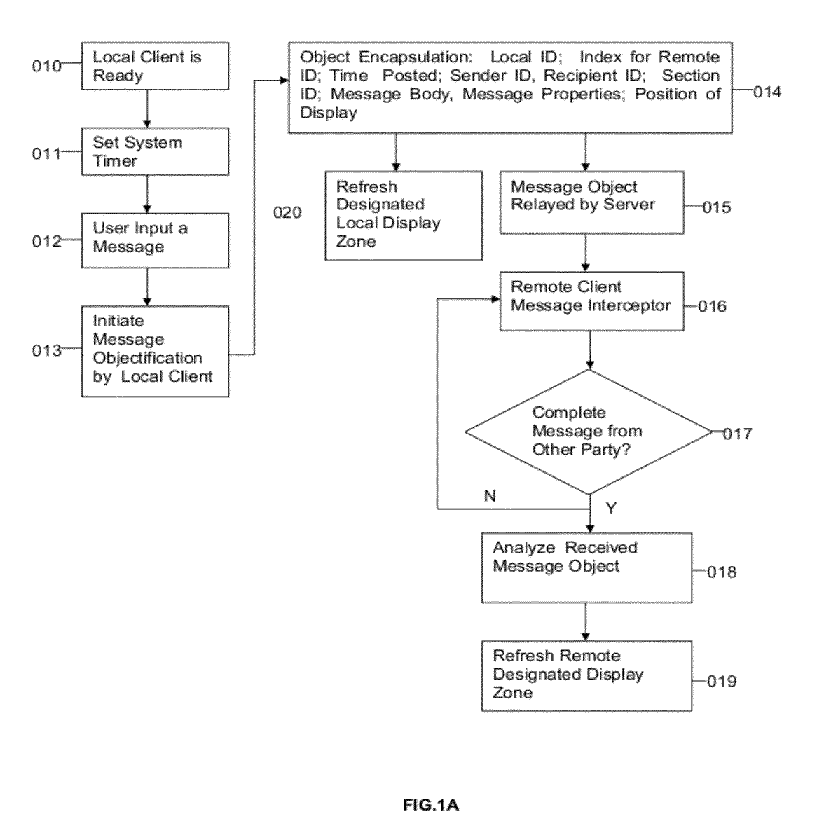

FIG. 2 refers to a typical IM client user interface in the prior art. Usually, it will have a Message Display Zone 100 and a Message Input Zone 200. In 100, all messages posted by all the participants in the same conversation are basically stuck in a single thread along the timeline. This traditional interface gives user very limited power in manipulating the posted messages, and hence reducing the power of communications of instant messaging.

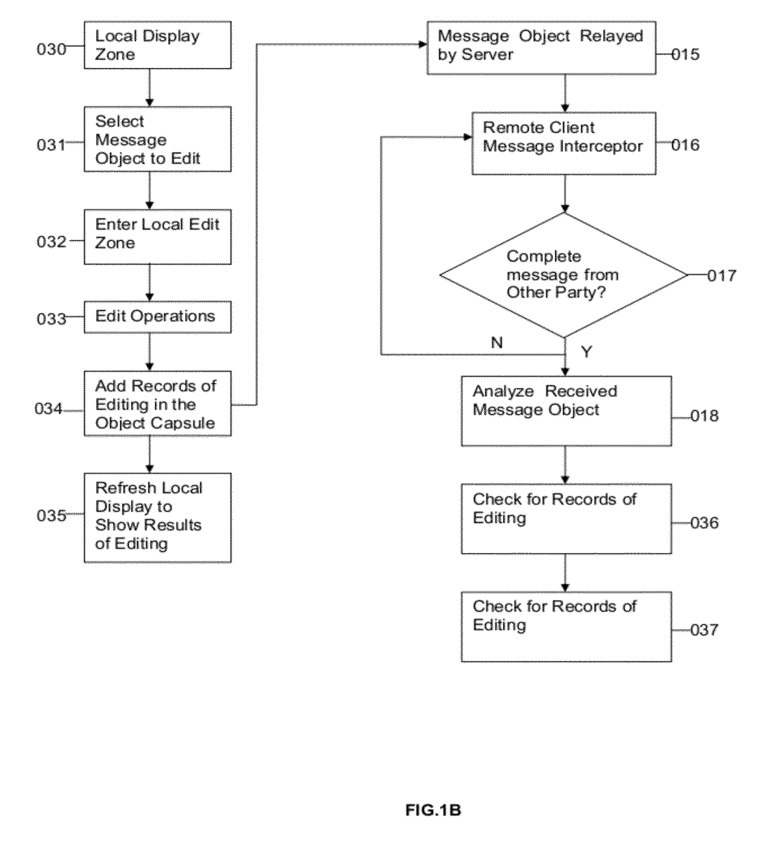

What the invention presents is a WYSIWYG (what you see is what you get) like message display interface, in which users can not only delete, edit, insert, append to textual information, they can also rearrange the order of message in any way they see fit, or drag & drop a message to anywhere they want, either within the original display zone or outside (into new display zones). Using the feature of in-place editing, FIG. 3 illustrates the spirit of the invention. In FIG. 3, all the messages posted into 100 are objects. If a user sees a typo in one of the message objects 101, he/she can select the object 101 and enter editing mode in-place 101′, and hence correct any typos or mistakes.

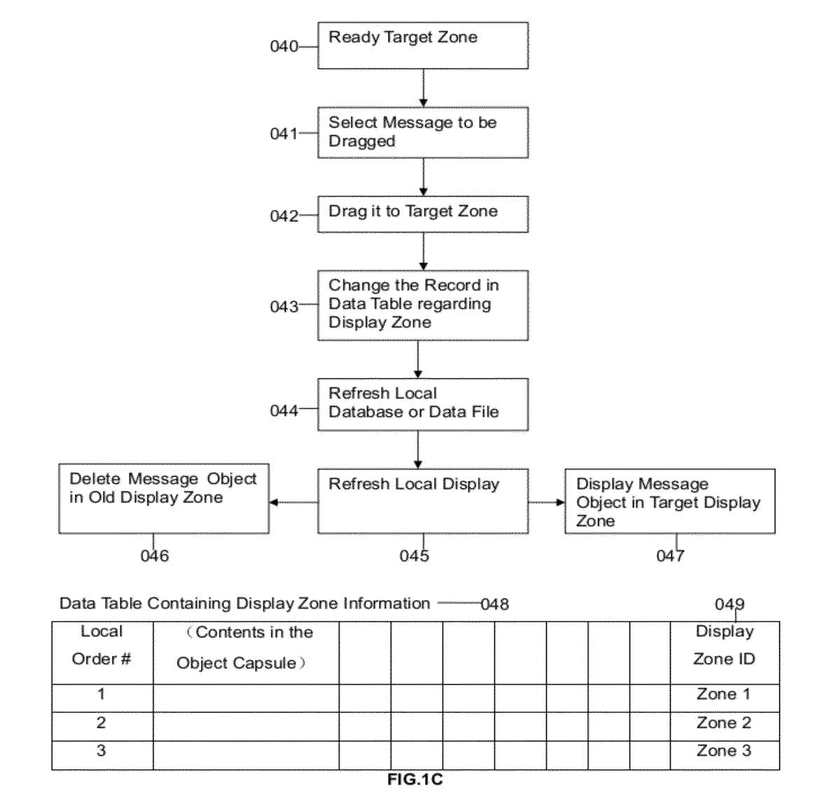

FIG. 4 illustrates yet another feature of the invention. In Message Display Zone 100, user selects one of the message objects 103 and highlights its appearance to call for more attention from the other parties.

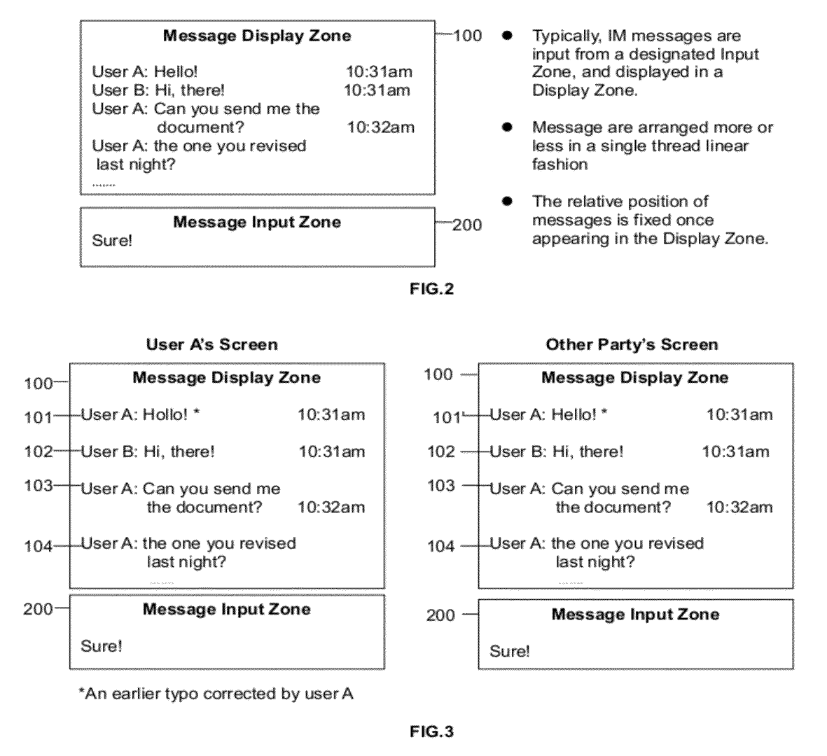

FIG. 5 illustrates yet another feature of the invention. In Message Display Zone 100, user instructs the system to send out ‘Read Receipts’ 113 for one of the message object 112 to each and every participant of the conversation, and collect and display feedbacks 114 from other parties.

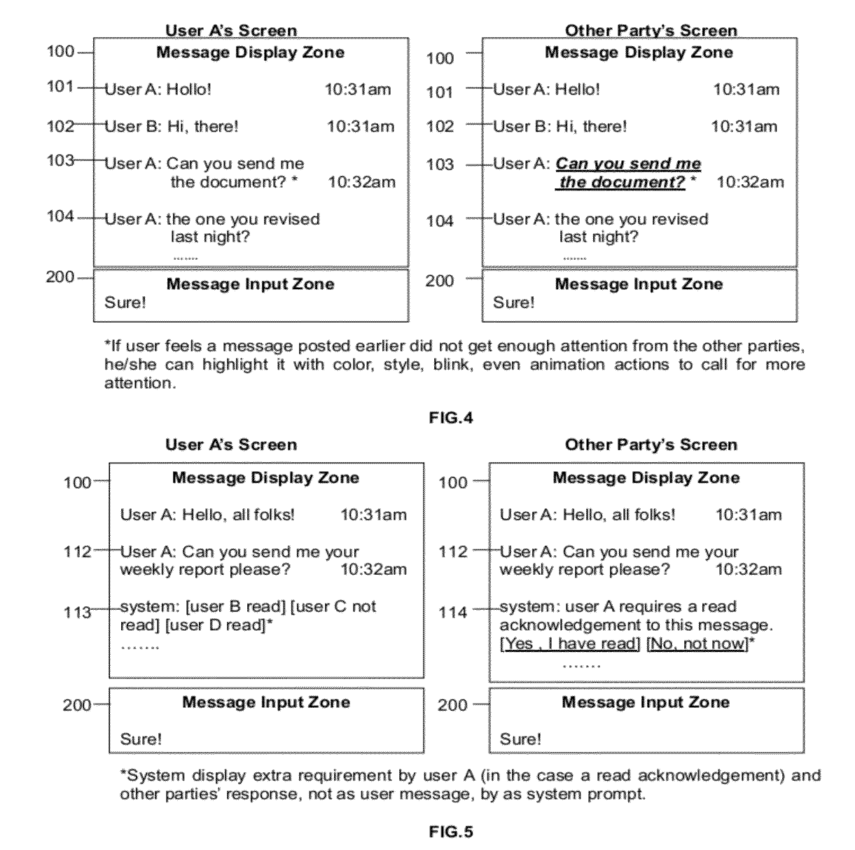

FIG. 6 illustrates yet another feature of the invention. In Message Display Zone 100, user rearranges the original order of message objects 103˜104, so the conversation can be better understood.

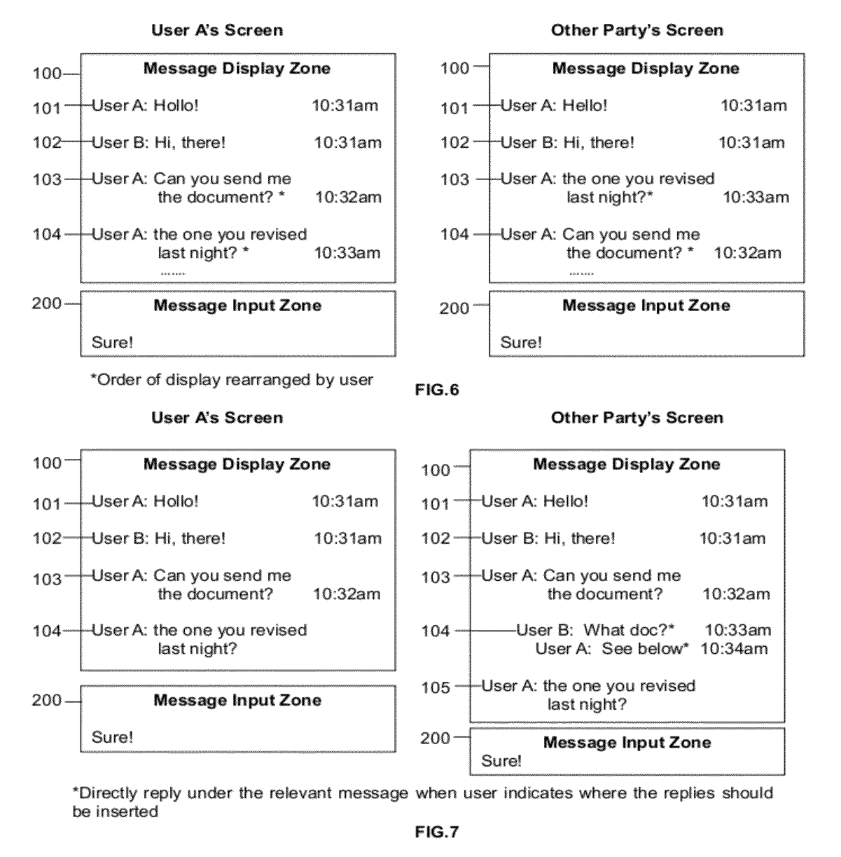

FIG. 7 illustrates yet another feature of the invention. In Message Display Zone 100, user B inserted his/her reply 105 to user A's question 103 in between two of user A's posted messages 103 and 104. User B also indented his/her answer so it can be more conspicuous. User A further inserted his/her answer 106 under user B's reply, again indented.

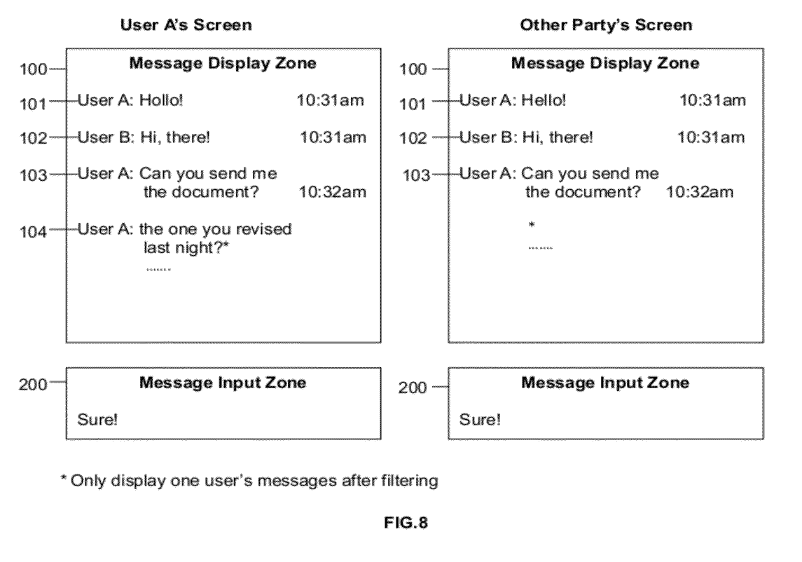

FIG. 8 illustrates yet another feature of the invention. In Message Display Zone 100, user B's messages all filtered out so only user A's message are left to display.

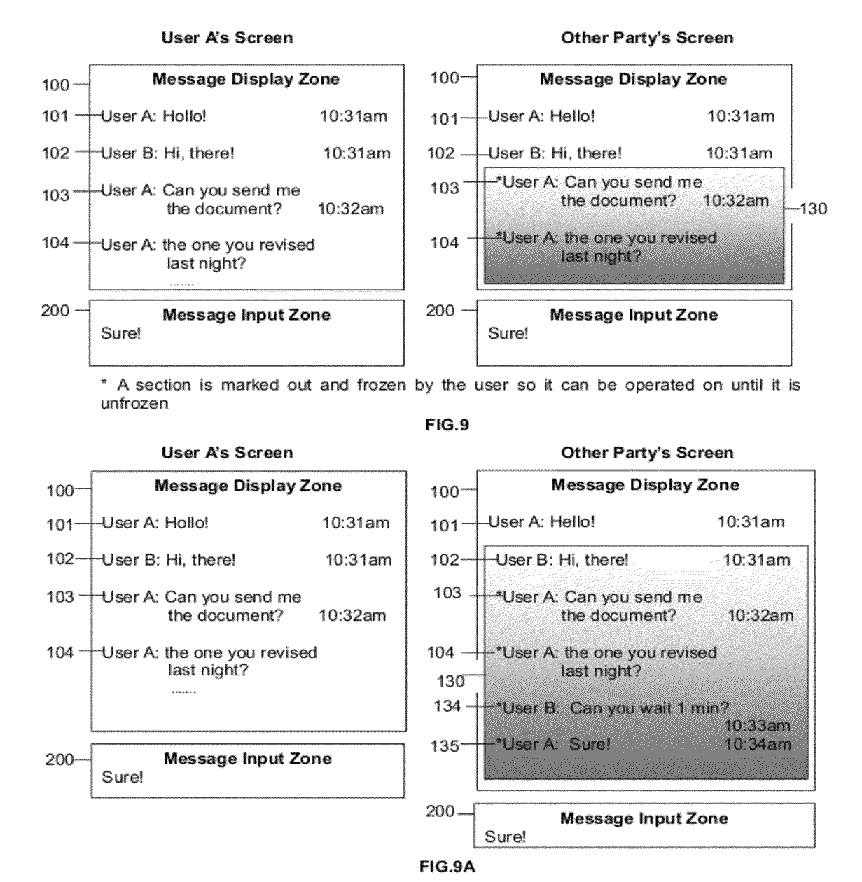

FIG. 9 illustrates yet another feature of the invention. In Message Display Zone 100, a section of the message flow 130 is frozen by one of the participants of the conversation. If this participant chooses to share his/her view to the rest of the participants, and all other participants agree the sharing, then this frozen section of the message flow will be displayed on all participants' display zone. Hence every one can look at the same section and work on it. Please note that the term ‘freeze’ or ‘frozen’ is used loosely here. A frozen section is only relatively fixed in the display zone and its size and position can change accordingly if new message objects 134˜135 are inserted, old message object altered or deleted from the section, as illustrated in FIG. 9A.

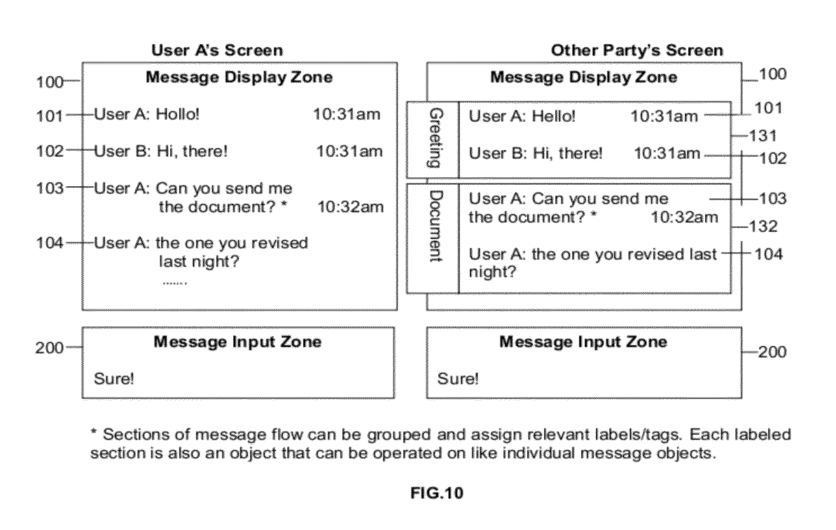

FIG. 10 illustrates yet another feature of the invention. In Message Display Zone 100, message objects 101˜102 are grouped by user and labeled as ‘Greeting’ 131, and message objects 103˜104 are grouped by user and labeled as ‘Document’ 132. User can quickly jump back to these previously labeled sections either through mouse click or search the labels.

Taking advantages of message objectification or encapsulation, the invented IM system is able to handle Multiple Threads of the conversation flow.

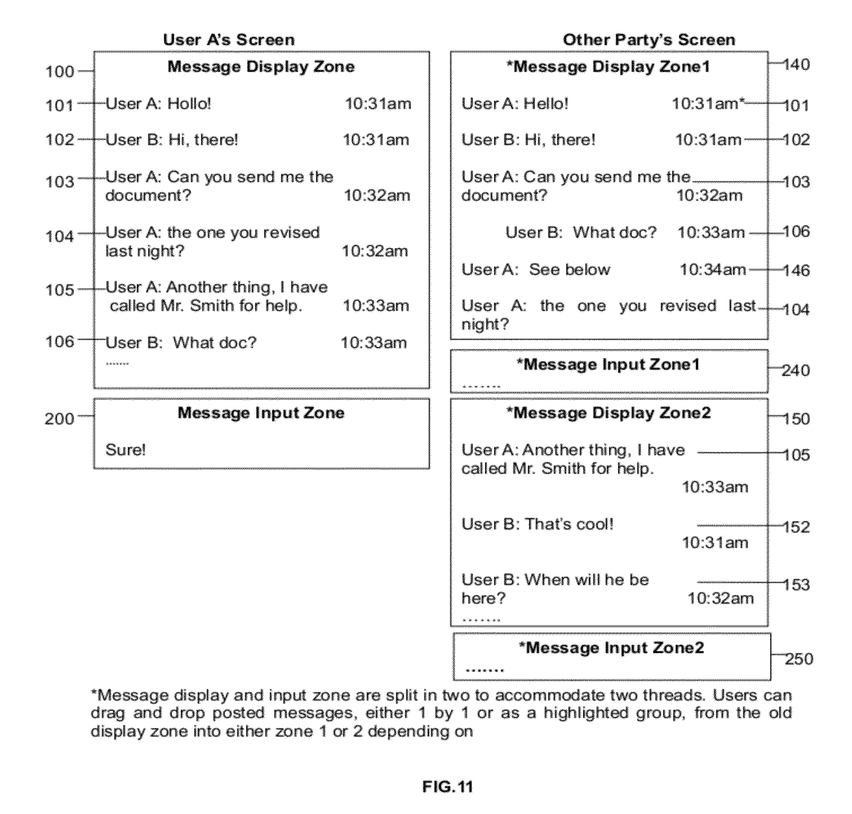

FIG. 11 illustrates the feature of splitting one single message flow in 100 into two or more threads 140 and 150 in the invented IM system. With this feature, message display and input zones are split in two or more to accommodate two or more threads. Users can drag and drop posted message objects, either one by one or as a highlighted group, from the old display zone 100 into either new zone 140 or 150 depending on the relevancy of the message contents, and new message input zone1 240 and message input zone2 250 are also created by the system for users to input new messages for different threads, and newly input message, such as 146, 152, and 153, from each input zone shall go directly to the corresponding display zone, and be placed in the user-intended place within each thread.

In the traditional single thread mode, user can activate a button to open a new window that contains a new display zone and an input zone. Alternatively, the button can be exemplified as a small bucket sitting at a corner of the screen. When user drag and drop a posted message or a selected group of messages onto this bucket, it will pop up and display a new window. Yet another embodiment is that user can simple drag and drop a posted message or a selected group of messages outside the old window, then a new window will be formed to contain the dropped messages.

User can continue to form more new windows this way. New windows can be formed from the old ‘mother’ window, or from an existing new window. Once created, all new windows have the equal status.

By dragging & dropping objects from an old window into a new window, the user can split a single flow of messages into multiple threads.

Once a new window is formed, user can continue to drag and drop posted messages from other windows to it, or directly input message from new window itself.

User can freely rearrange messages among multiple windows.

If a posted message is dragged out of a window A, say, into window B, there are two ways to arrange the message display in window A:

The dragged message disappears from window A and only appears in window B;

The dragged message appears both in window A and window B;

The second way allows the concern message to be dragged to and appears in multiple windows C, D, etc.

Messages in a new window can be dragged and dropped back into an ‘old’ window

Alternatively, there is a button or command that allow user to restore the original look of the mother window

### Handle Multiple Thread Windows

There are a number of additional features that are disclosed in the following paragraphs:

Naming: A default name is given to each thread window, which can be edited by user

Alternatively, such name can be proposed by the system after the system analyzes the semantic meaning of all posted messages in this window and detect its theme, and use the theme as the name.

Merging: Two or more thread windows can be merged into one

By default, the order of the messages in the merged window is dictated by the post time. This requires the system maintains an accurate and standard post time for all messages in all windows. This can be achieved by synchronize the timers in all client side with that of the central server.

Alternatively, user can pre-fix the order of messages in each window before the merge, and the pre-fixed order will be preserved in the merged window after the merge.

3+ Way splitting: By assigning different destinations for different messages in the ‘mother’ window, user can split a single thread into 3 or more thread in a single click of button or command.

Saving: Contents in each window can be saved individually into files or database, either locally or on the server. Saving can be done either at the time of user exiting the client software or during the conversation.

Reloading: When the client software is re-opened, user can choose to reload old messages into a single thread or multiple threads according to the saved contents.

### Auto Splitting

User can set up condition(s) for existing or incoming messages, so every message that fits that condition(s) will be automatically redirected to the new windows

One such condition can be designated keyword(s) in the messages. For example, all messages contain the word “travel” will be redirected into a new window with the proposed name “Travel”.

Semantic network can be used to expand simple keyword settings.

Alternatively, the condition can be all messages from a user by the name “Joe”.

Alternatively, the condition can be all messages that contain files.

All incoming messages that fit the predefined conditions, will be automatically sent to be display in the new windows as new thread

### Shared Thread View or Not

The invented IM system grants the right for any one of the participants of the conversation to split a single message flow into multiple threads. It also grants the right for any one of the participants of the conversation to decide whether to share his/her view of the thread splitting to other participants of the conversation. Also it grants the right for any one of the participants of the conversation to decide whether to view the thread splitting results presented by other participants of the conversation.

Let's use the simplest case, a dialogue between user A and B, to further illustrate the point. If user A chooses not to share his/her view of thread splitting, or user B chooses not view user A's results of thread splitting operations, each user will be able to maintain his/her own preferred views without affecting other party's experiences.

Say, if user A has split the thread into two streams, Thread1 and Thread2, while user B still maintain a single thread.

Messages posted by user A, no matted in Thread1 or Thread2, will always appear in the original single thread in front of user B.

Messages posted by user B will be directed by the system into either Thread1 or Thread2, depending on where the immediate previous message from user A is in, which user B is replying to.

Some time errors do happen if only time of posting is used to decide which thread to direct a new message from user B. Other factors/cues can be considered, such as tree-node type of indentation, keyword/theme matching between messages and name of window. No matter what, user A can always rearrange messages that are assigned by mistake.

### Buffer Zone for Input

The invented IM system also has message buffering functions.

For messages input from the Input zone, before a message gets finally posted into the display zone, it can be saved temporarily into a buffer zone for later posting. In one embodiment of the invention, there is a buffer zone for user to temporarily store messages that are not ready to be sent yet. Multiple messages, including file transfers, can be temporarily stored in the buffer zone. Later message(s) can be simply copied or dragged out of the buffer zone into its destination. In this way, input zone can be cleared and ready for inputting other message(s).

For messages input from the Display zone, User can choose how a message is revealed to other parties during its input. For example, other parties can view each letter/character of the message as it got typed. The is call ‘letter-for-letter’ mode. Or alternative, other parties can only view the message after user A hits a send button or special keys (enter or alt+s).

Web or desktop based IM tools are among the more popular communication methods in modern work and life environments. A great amount of information and knowledge are exchanged thru IM tools daily, but few of them are captured and preserved well for future reuse. This invention presents a method that helps extract useful information and knowledge from IM conversations and organize them in the format of knowledge bases with certain structures and rules, as well as maintaining these knowledge bases for future reuse.

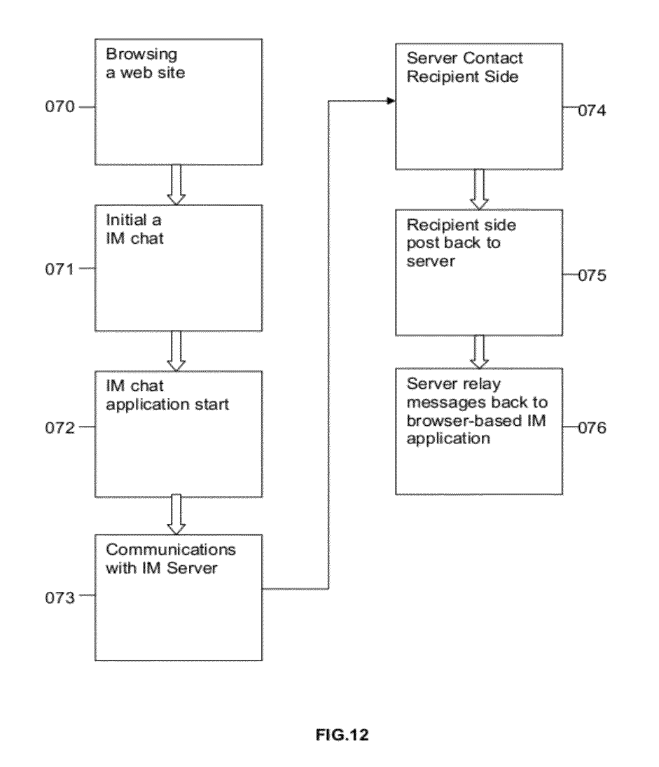

FIG. 12 illustrates the process of an IM communications between a web browser based system and a desktop based system.

The process may start when a user A is browsing a website 070 and run into a question. He/she initiates an IM chat session 071 from within the web browser, and a web browser based IM chat application 072 starts. IM messages are sent through IM server 073 and relayed to a recipient user B who may use a desktop based IM client 074. The recipient user B receives and replies the message of user A, and the replies are routed back through the server 075 to browser based IM chat client 076 and displayed to user A.

### Button Action: Query the K/B

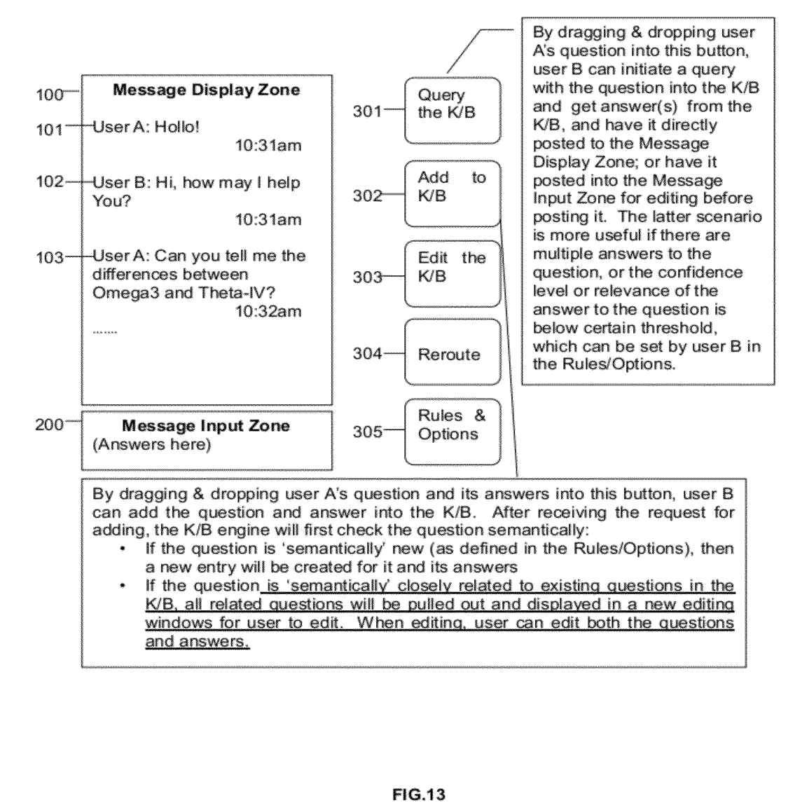

FIG. 13 illustrates one of the features in the invented IM system, where user A posted a question, and user B the recipient of the question message can interact with the knowledge base in a number of ways.

In one embodiment of the invention, by dragging & dropping user A's question message, which has be objectified by the system, into a button name ‘Query the K/B’ 301, where K/B stands for Knowledge Base hereinafter, user B can initiate a querying process where the question is used to query the K/B and get the semantically most relevant answer(s) from the K/B, and have it directly posted to the Message Display Zone; or have it posted into the Message Input Zone for user B to edit before showing it to other parties.

The latter scenario is more useful if there are multiple answers to the question, or the confidence level or relevance of the answer to the question is below certain threshold, which can be set by user B in the Rules/Options.

By “semantically relevant”, we mean by using semantic network method to judge the relevance of each item.

### Button Action: Add to K/B

FIG. 13 further illustrates a feature of the invented IM system, in that by dragging & dropping user A's question and answers to it into this button name ‘Add to K/B’ 302, user B can add the question and answers into the K/B. After receiving the request for adding, the K/B engine will first check the question semantically:

If the question is ‘semantically’ new (judging by the semantic distance as defined in the Rules/Options), then a new entry will be created for it and its answers. This new entry will be properly indexed and assimilated into the K/B.

If the question is ‘semantically’ closely related to existing questions in the K/B, all related questions (with a cut-off point as defined in the later section discussing Rules/Options button 305) will be pulled out and displayed in a new editing windows for user to edit. When editing, user can edit both the questions and answers. User can choose to combine questions and/or answers into a new question, while with the option to delete old questions/answers or not.

### Button Action: Edit the K/B

FIG. 13 further illustrates a feature of the invented IM system, in that by activating a button name ‘Edit the K/B’ 303, user enter an interface 400˜500 to search and view the K/B.

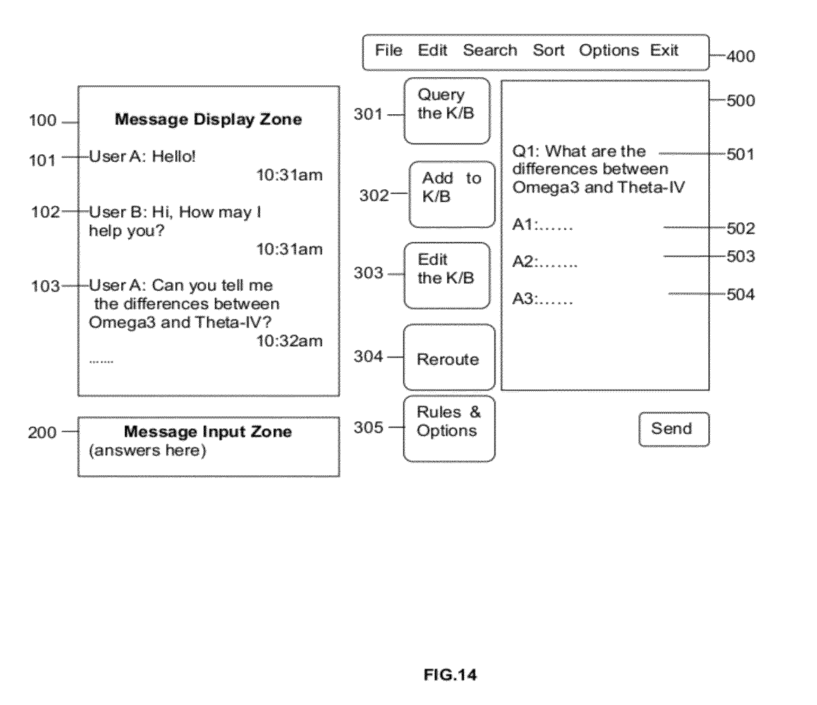

FIG. 14 illustrates more details of the K/B editing and search interface 400˜500. 400 consists of a number of common menus for the interface. 500 displays the search results and an editing interface. In the search results, all semantically related questions/answers will be listed together. User can select any one item 501˜504 in 500 and edit it. Since each item is objectified by the system as disclosed in previous sections, there are many WYSIWYG-like operations that can be applied during the editing process. It is worth noting that when editing, user can edit both the questions and answers, and user can choose to combine questions and/or answers into a new question, while with the option to delete old questions/answers or not.

### Query

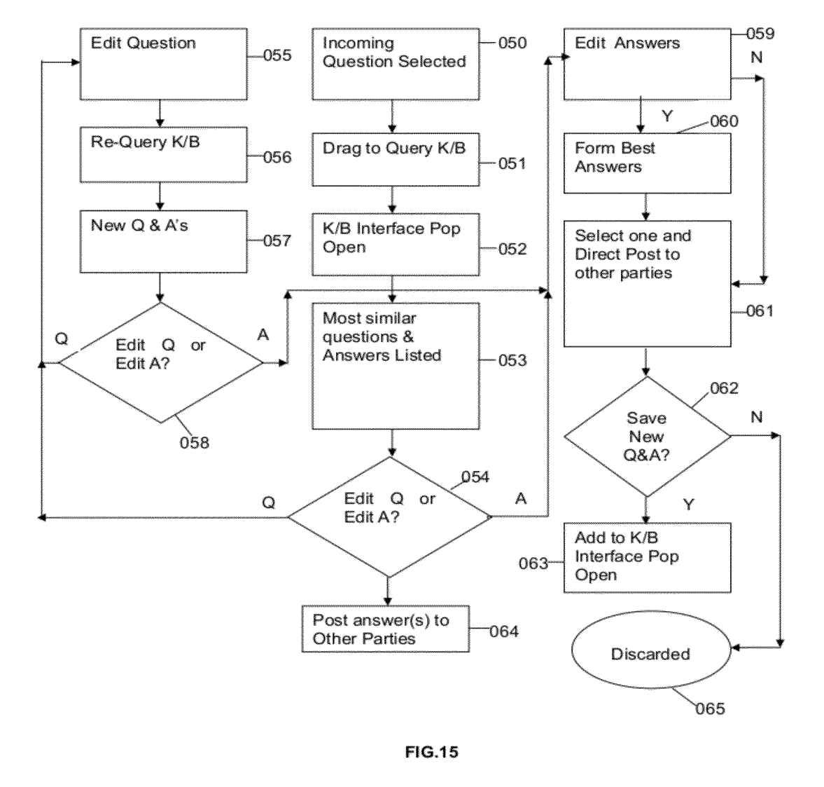

FIG. 15 further illustrates in more details the recursive logic process for querying the Q & A or knowledge base in the invented IM system.

In FIG. 15, a question from user A is selected by user B in 050, and dragged-and-dropped to the button ‘Query the K/B’ in 051, then a user interface for the K/B is open up in 052, as results for the query, most similar questions and answers will be listed in the interface in 053.

At this point 054, depending on the judgment of user B to the returned query results, he/she can choose to directly post the answer(s) to user A, or he/she can choose to edit either or both the question for re-querying, and/or the answers before posting back to user A.

Assume user B decides to modify the answers first in 059, he/she will use the knowledge base interface to edit and form the best answers for the question in 060, and select one or more best answers and post back to user A in 061. Before or after such posting, user B can also choose whether to save his/her modifications to the answers into the knowledge base in 062. If user B chooses not to save, all his/her modifications will be discarded 065. If user B chooses to save, the Add to K/B interface as disclosed in previous sections will be opened up for new question and/or answer insertion.

If user B decides to edit the question first in 055, he/she will use the newly edited question to re-query the knowledge base in 056 and retrieve new results in 057. At this point 058, user B can again choose whether to edit the question and/or the answers. If user B decides to edit the question again, he/she will repeat the steps in 055˜057; if user B decide to modify the answers, he/she will follow step 059˜063 as previously described.

### Button Action: Reroute

FIG. 13 further illustrates a feature of the invented IM system, in that by activating a button name ‘Reroute’ 304, user B can request third-party help on answering a question from user A.

Sometimes a question posted by other parties is out of the domain of expertise of user B. User B may attempt to answer such questions, but she/he may also want to get a second opinion from someone else.

By dragging & dropping the question and/or possible answers to the Reroute button 304, they are delivered by the IM system to another third party user C, presumably the most authoritative expert for this type of knowledge domain.

User C's IM software will alert him/her the incoming information. Then he/she will try to answer or correct and incoming answer with the best of his/her knowledge, and post them back. In one embodiment of the invention, as an extra measure of convenience, the incoming information can be directly displayed in user C's Message Input Zone for him/her to directly edit, and then post back to user B.

### Button Action: Rules/Options

As mention before, FIG. 13 further contains a feature of the invented IM system, in that by activating a button name ‘Rules & Options’ 305, user B can set threshold for the confident level of the answers to a question posted by user A, as well as other functions that will be disclosed in the following paragraphs.

First, button ‘Rules & Options’ 305 is used to set the threshold for the confidence level or relevance of the answer to the question. Using techniques known in the field of natural language processing (hereinafter NLP), both questions and answers are parsed into phrases and their senses are determined by one of the semantic network (one example: WordNet) analysis method. A score is calculated for each question and each answer based on NLP and semantic network analysis. Then the score is normalized to a range of 0˜100%. User can choose any number in between as the cutoff threshold, say, 70%. If below such preset threshold, answers retrieved from the K/B will not be displayed.

Second, ‘Rules/Options’ button 305 is also used to determine if a user is qualified to Add to K/B and/or Edit K/B. Rules can be further detailed as to which particular fields a user is qualified or not. One of the many embodiments of the invention would be for the IM to provide an interface that lists all possible fields/domains covered by the K/B, and for the user to click and select. User can also assign or be assigned a value of expertise to each field he/she selects. The range for the value of expertise can be 1˜10, with 10 as the most sophisticated expert. All users qualified to add to or edit the K/B must ‘sign’ their work and leave contact information. With a signature, system can link the answers with the level of expertise of the makers, and viewers can judge the confidence/faith on the answers.

Third, ‘Rules/Options’ button 305 can also be used to set whether a certain item in the K/B can be deleted or overwritten by others. Usually, an item created by a more sophisticated expert cannot be deleted or overwritten by experts with less sophistication. They can add to existing answers, though.

### Themes or Topics for Multithreads

By splitting IM conversation into multiple threads as disclosed in previous sections, user can assign a theme to a particular thread, and hence limit the semantic scope of the messages in each thread, and work as a way of reducing ambiguity of terms/phrases. Theme for a thread can be decided either unilaterally or jointly decided by all parties in the IM conversation thru negotiation. If one party among all participants has superiority in terms of the expertise level, he/she can have a final say on the theme to use. Theme lists can be the same as the domain phrase lists commonly used by this group of IM users. They can be presented in multiple levels like a tree structure. Or be presented in a user interface where user can enter a few letters and system will show a list of possible whole words

### Reduce Human Interactions

The invented IM system also designed function and capabilities to reduced human interaction when building the knowledge base. The invented IM system is able to extract questions and answers automatically from IM conversation flows. The key here is to correctly parse questions and answers from the conversation flows. For example, questions and answers have nature marks that can be used by the system as identifiers.

For question identification, often questions can be easily parsed out by question mark “?”. The entire sentence, starting from the previous period mark, can be regarded as the question. Specific words, such as When, Who, What, Why, What, How, Can, May, Do, and etc., appearing at the beginning of a sentence can be used together with question mark to help identify questions

For answer identification, in a normal typical IM conversation flow, answers are assumed to follow questions immediately (or if it was originally not, the order can be rearranged by operating on the objectified messages in the flow). It will stop at where the next question starts. Usually, in an IM conversation, questions are from one party, and answers are from another party. This rule of thumb will also help parse questions and answers.

If there is already a domain Q & A base built for the system previously (either manually or automatically), it can be very helpful for the later extraction of the Q & A's from IM conversation flows. Existing Questions and Answers in the Q & A base can be used as marked samples to train a pattern classifiers such as Bayers, SVM, Neural Network, which are well known to people skilled in the field call Pattern Recognition, and the trained classifier can be used to pick out questions and answers in the new IM message flows.

Questions and Answers in the Q & A base can be clustered into clusters based on their semantic meanings. Clustering can be based on similar questions alone, similar answers alone, or similar questions and answers together.

### Assign Tasks from IM

Often people try to use IM to assign tasks to self or other parties. But IM is bad at tracking these assignments late. The disclosed invention designs a function for user to assign task directly from IM conversations and facilitate the management of such assignments late.

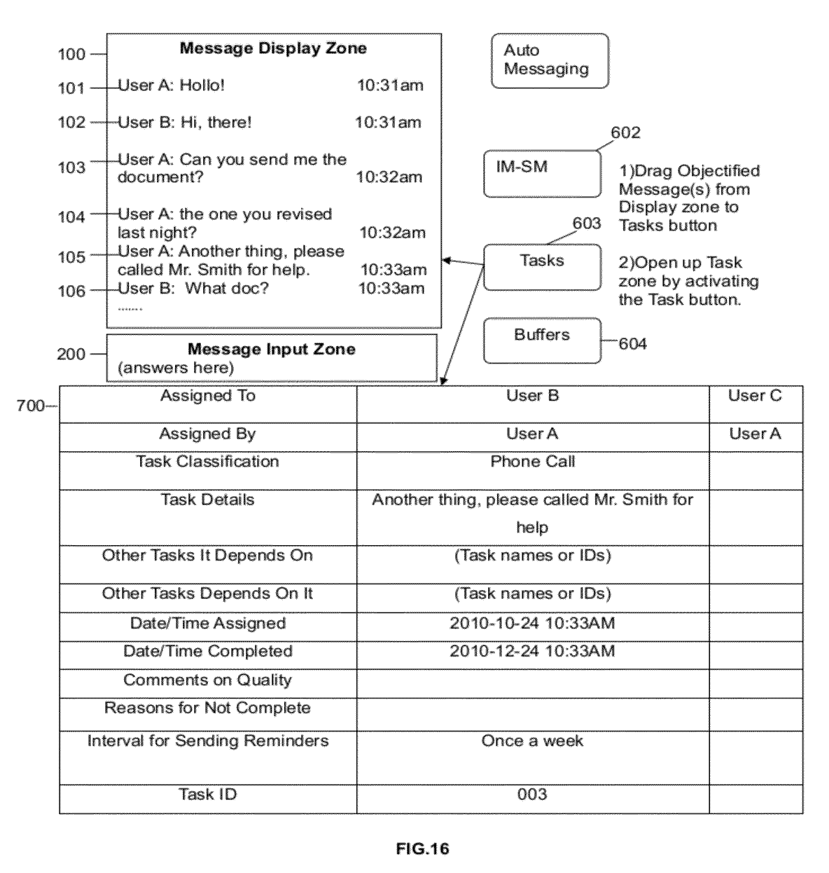

In FIG. 16, one embodiment of the invented IM system is illustrated, where the IM user can drag and drop objectified message(s) from Display zone to a ‘Tasks’ button 603 alongside the Display zone, which in turn can pop up a Task zone 700, or directly into a Task zone 700. Alternatively, user can select the Task option from a drop-down menu after clicking objectified message(s).

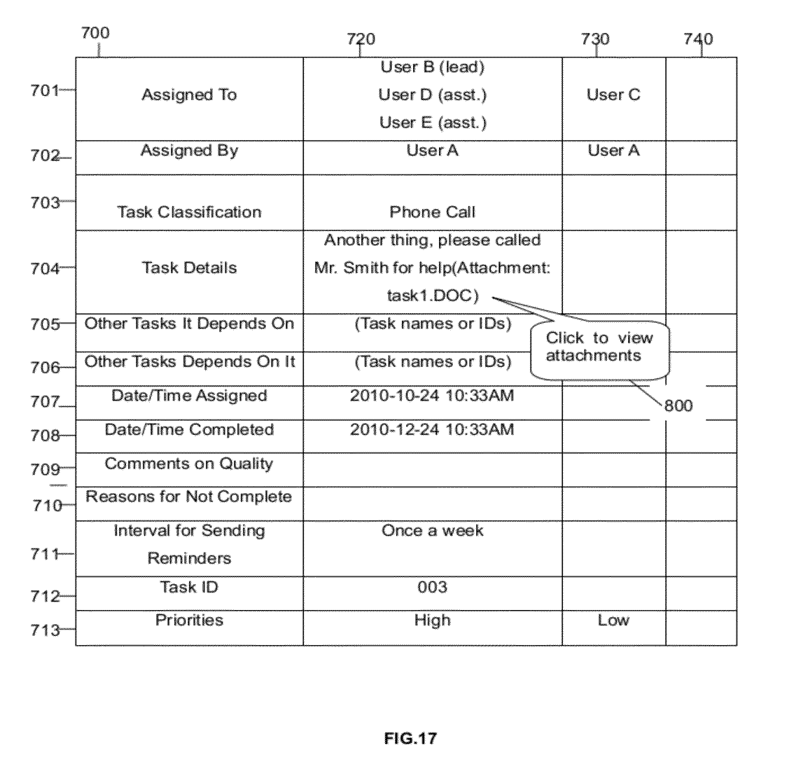

FIG. 17 further illustrates the task zone 700 of the invented IM system in more details.

In this embodiment of the invention, advantages of message encapsulation or objectification are thoroughly utilized. Objectified message(s) contain many information that can be utilized to fill the Task zone automatically, such as ‘Assigned To’ 701, ‘Assigned By’ 702, ‘Task Details’ 704, ‘Date/Time Assigned’ 707, and etc. If the message contains a file, it will be transposed as an attachment to the ‘Task Details’ 704, which can be opened up to view details in 800.

Task ID 712 is a unique identifier created by the system to better track the task later. User can also set values for other properties such as task classification in 703, interval for sending reminders in 711, priority in 713, while the system can decide the contents for fields such as 705 and 706.

Assigner can always edit any field on the task zone 700. But an option is given to allow or disallow assignees to edit the contents on each field. For example, Assignee User D is only allowed to edit field ‘Reasons for Not Complete’ 710, while User B is allowed to edit more fields such as ‘Comments on Quality’ 709 or ‘Date/Time Completed’ 708.

System also presents another option on whether assignees can overwrite original contents in each field or are just allowed to append to them.

There can be multiple Assignees, and one or more of them can be assigned as leaders, and other be assigned as assistants, as illustrated in 720, where user B is assigned as the lead, while user D & E are assigned as assistants.

Multiple tasks can be viewed in the same table 700, as illustrated in 730˜740.

### Task Zone: Web Browser Version

The Central Server of the system maintains tables for information on the Task zone, which can be displayed alternatively in the web browser.

More or less fields and options on user operations can be delivered in the web browser version, similar to the client side version.

### Tracking of Tasks

Assigner can set up Reminders from the Task zone interface, or its equivalent, the web browser version. The reminders can be sent at a fixed time interval, such as once a week. Or alternatively, in a speed-up manner that sends more frequent reminders when it approaches the milestones/deadlines. Contents of reminders can either be fixed or variables. For example, it can be “Task #1, Time to completion: 15 days”, or more friendly: “Hurry up, pal. Only 3 days left for this . . . ” Reminders can be sent as pop-up messages to the client side, or to emails of Assignees.

### Responses to Task Reminders

The preferred embodiment is that the reminders sent to assignees will show up as a pop-up windows on his/her client side. Without interacting with the pop-up, the reminder will always show.

Assignee can either close the pop-up window, or click a button of acknowledgement, which will be sent back to the server and then to the Assigner.

Alternatively, Assignee can add new comments on this task in the reminder window, which will also be sent to the server and the Assigner.

Alternatively, Assignee can open up the task zone, or its web browser version, to edit the Task list.

### Preview Contents in Task and Buffer Button

Again in FIG. 16, by mouseover a Task button 603 or Buffer button 604, a new window will pop up to allow the user to preview the tasks or buffered contents. Further clicking a list in the content will bring up the full windows of Tasks or temporarily saved contents

Remove the mouse focus without further clicking, the pop-up windows will disappear.

### Merge of Tasks

Two or more tasks with similar natures can be merged into one to facilitate the task management.

### Reminders in Email

The system can send reminders to either or both Assigner/Assignee regarding the task and its details. In order to do this, the system needs to have correct emails address in the registration information provided by users. The reminder email may contain all information regard the task, with or without a reminding statement before or after. Alternatively, the reminder email may contain URL Links for user to click and view the entirety of the task, or acknowledge the receipt of such reminders.

### IM to SM

FIG. 16 further illustrates yet another feature of the invented IM system regarding task management. If user A posted an IM message to user B, and did not get a response in a specific time period, he/she can activate the IM-SM button 602 and request the system to automatically forward the IM message as a SM to user B. Also, if the system has the telephone # of the Assigner and/or Assignees, it can send task reminder as SM to the Assigner and/or Assignees.

### Tasks Assigned Thru Emails

Previously we have disclosed ways to send task reminders to emails. On the other hand, tasks can be assigned thru emails and then appear in the Task zone or its web browser version.

In one embodiment, Assigner (user A) sends an email to Assignee (user B), and an email address that represents the invented IM system. Assume user B has pre-registered with the system with the corresponding email address (either as IM ID or not), after receiving the email the system can look up user B's information and repost the contents of the email to the Task zone of both user A and B.

For example, the Assigner and Assignee can be user A and B; the email time can be used as ‘Date/Time Assigned’; the subject of the email can be the ‘Task Classification’; the content of the email can be used as ‘Task Details’; etc.

The system can also send an IM message to either or both user A and B to inform them that a new task has been created from the email.

Another embodiment is that user A or B allow the system to read his/her emails and automatically retrieve emails with specific marks, and repost them as tasks in the Task zone

For example, user can assign keyword(s) such as ‘Task to IM’ in the subject line of email as the specific mark for the system to look for. Hence the system will look for every emails with that keyword or combination and repost them as tasks in the Task zone.

Alternatively, user can embed a specific URL link in the email body as the mark

Alternatively, all emails sent to Assignees can be auto forwarded to the system email box. So the Assignee does not need to enter the system email address. Neither does the system need to log into Assignees email box to look for tasks.

Such forwarding can be selective: Only emails fit certain conditions will be auto forwarded.

Multiple Assignees can be listed in the emails: Lead assignees will be in the Sent to fields, while assistants will be in the CC: field.

Task Details can be included in one or more attachments to the email.

There is an Email-Task button and Email-Task zone for user to manage the options and transactions of emailed tasks.

### Disclaims

The principles and spirits of the present invention are applicable to a variety of computer hardware and software configurations. The term “server” or “client” or “computer hardware” or “hardware,” as used herein, refers to any machine or apparatus that is capable of accepting, performing logic operations on, storing, or displaying data, and includes without limitation processors and memory; the term “system” or “server software” or “client software” or “client side” or “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention.

Although the inventor had went great length to disclose and explain in details many functions and features of the invented IM system, it should be understood that all the disclosures and explanations are for illustration purpose only. To those skilled in the art, there exist multiple other ways to implement this invention without departing from or violating the spirit and scope of the invention as defined by the appended claims. Also, the disclosed invention is to be applicable to the widest scope covering various of alternatives, modifications and equivalents consistent with the principles and features. The terminology and phraseology used is for the purpose of describing exemplary embodiments and should not be considered limiting. For the purpose of clarity, details relating to technical material that are known in the technical fields related to the invention have not been described in detail so as not to unnecessarily obscure the present invention.

1. In a generic instant messaging or interactive online chat system, hereinafter referred to as IM system, comprising of at least one zone or window for message inputting and message displaying, or at least one zone or window for message inputting and at least one zone or window for message displaying, as well as at least one functional button, a method and system of encapsulating or objectifying a user input message with a number of related information together into an objectified message or message object or simply an object or a capsule, wherein said message may include but not limited to any one or any combinations of the following items: plain text; audio files; image files; video files; any other types of computer files; other objects; wherein said information comprises: Unique System ID; Local ID; Index for Remote ID; Time Posted; Sender ID; Recipient ID; Section ID; Message Body; Message Properties; Position of Display; Permission to make changes on any part of said object; and etc., as well as information related to methods of operations designated by the system to operate on said object or capsule.

2. The method and system of claim 4 further comprising a method and system to make the invented IM system function just as a traditional IM system in the prior art with no effect on any user experiences for users who do not wish to take the advantage features enabled by message encapsulation and/or objectification.

3. The method and system of claim 1 wherein said methods of operations may include but not limited to one or any combinations of the followings: sending; receiving; dragging & dropping within the same said zone or window or outside the current said zone or window; editing; deleting; sorting/filtering according to certain criteria; adding expressions; hyper-linking; changing properties such as font and color; reposting; calling-out for more attention; and etc.

4. The method and system of claim 1 further comprising a method and system of presenting a What-You-See-Is-What-You-Get or WYSIWYG-like user interface to hold and display said objectified messages from all users of an IM session, and allowing users to initiate various of WYSIWYG operations on said objectified message or messages, either one by one or as a highlighted group.

5. The method and system of claim 4 wherein said WYSIWYG operations may include but not limited to one or any combinations of the followings: sorting or rearranging said posted message objects in any direction within the said zone or window; dragging-and-dropping said posted message object or objects to anyplace within the same said zone or window, or outside the said zone or window; in-place or in-line editing of said objectified messages per se; formatting; requesting Read Receipts from other participants; rearranging the original order of message objects; inserting new replies to anywhere in the posted message flow; indenting an existing or new message; filtering out unwanted messages by message attributes; freezing a section of the message flow to operate and unfreezing it after operation is done; grouping and labeling individual message object or sections of message objects from the message flow.

6. The method and system of claim 4 further comprising a method and system for each user of an IM conversation, either during or after a normal IM session, to choose whether to share his/her results of said WYSIWYG operations to any other participants of the original conversation and/or newly added participants; and to decide whether to grant the right to allow other participants, old or new, to alter his/her results of said WYSIWYG operations; and for any other users, old or new, to each individually choose whether to view the results of operations of the first said user on their own screen; and for any other participants, old or new, to individually decide if they want to accept said right to alter the results of operations of first user if it is granted by the first said user.

7. The method and system of claim 4 further comprising a method and system for one single message flow to be split into two or more threads of messages, and for the message display and input zones to be split in two or more to accommodate two or more split threads as well.

8. The method and system of claim 4 further comprising a method and system for users to drag and drop posted message objects, either one by one or as a highlighted group, from the old display zone into new display zones, or to drag and drop messages in a new window back into an ‘old’ window, or to activate a button or command to open a new window that contain a new display zone and a input zone, or to provide a button or command that allow user to restore the original look of the original window.

9. The method and system of claim 7 further comprising a method and system for user to recursively form more new windows for more threads of message flows, in that new windows can be formed from the old ‘mother’ window, or from an existing new window, with each new window has the same status and rights of old windows.

10. The method and system in claim 7 further comprising a method and system for user to set up at least one condition for existing or incoming messages, so every message that fits that condition(s) will be automatically redirected to the new windows for new threads.

11. The method and system of claim 7 further comprising a method and system for any one user of an IM conversation to decide whether to share his/her view of the thread splitting to other user(s) of the same conversation, as well as for any other user(s) of the conversation to decide whether to view the thread splitting results presented by first said user.

12. The method and system of claim 1 further comprising a method and system for user to temporarily store one or multiple said messages before they are ready to be sent out to other user(s), in a system provided buffer zone from where said message objects can be simply earmarked for sending or copied or dragged-and-dropped into its designated display zones for other user(s) in the conversation to view, wherein said buffer zone can be a separated zone of its own, or be part of the message input zone.

13. The method and system of claim 1 further comprising a method and system for the message inputting party to have options on how the message is revealed to other parties during its input, either for messages input within the message display zone or message input zone, wherein said options may include but not limited to any one or combinations of the followings: allow other parties of the same IM conversation to view each component of the message as it got composed by the message inputting party; allow other parties to view the message only after the message inputting party initiating the send operation.

14. The method and system of claim 4 further comprising a method and system for first user to initiate operations of querying an existing knowledge base with a question in the message flow and review/edit query results returned by the knowledge base, wherein said operations of querying may further include a method and system for said first user to reroute said question and proposed answers to other users to seek help on answering said question, before or after the first user querying the knowledge database, wherein said query results can be directly posted to the Message Display Zone, or alternatively posted into the Message Input Zone for said first user to review/edit before revealing to other parties.

15. The method and system of claim 4 further comprising a method and system for user to add questions and answers to an existing knowledge base, and for the system to check whether the questions and answers are semantically similar to existing questions and answers in the existing knowledge base, so the system can decide whether to place the newly added questions and answers as complete new and independent entries, or as part of a group of similar questions and answers.

16. The method and system of claim 7 further comprising a method and system of assigning at least one topic or theme to a particular said thread, wherein said topic or theme for said thread can be arrived through one or any combinations of the following ways: being proposed by the system in accordance to the content of said thread; being decided either unilaterally; being jointly decided by all parties in the IM conversation through negotiation.

17. The method and system of claim 4 further comprising a method and system for user to assign tasks to self or other parties directly from IM conversations and to manage such assignments late through a task management zone or interface, or its web browser equivalent, associated with the invented IM system.

18. The method and system of claim 17 further comprising a method and system for user to set up reminders for each task assignment and for system to alert either or both assigner and assignee at the predefined points of time, wherein said alerts can be sent via IM, Email, Wireless SM (Short Message), phone, or any other means.

19. The method and system of claim 17 further comprising a method and system for user to assign tasks through email messages and for the system to assimilate the task information extracted from the email messages to the task management zone of the invented IM system or its web browser version.
